(19) United States
(12) Patent Application Publication
(10) Pub. No.: US 2020/0324710 A1
(43) Pub. Date: Oct. 15, 2020

(54) MODULAR VEHICLE CARGO RACK SYSTEM

(71) Applicant: Matthew Geiger, Garner, NC (US)

(72) Inventor: Matthew Geiger, Garner, NC (US)

(21) Appl. No.: 16/382,839

(22) Filed: Apr. 12, 2019

(51) Int. Cl. B60R 9/06

(52) U.S. Cl. CPC B60R 9/06

(57) ABSTRACT

A three-part modular vehicle cargo rack system with a number of horizontally oriented crosswise support beams, a number of vertically oriented lengthwise support beams, a number of horizontally oriented lengthwise support beams and a connection support beam that fits into a receiver hitch of a vehicle. Vertically oriented, hollow, open-ended support beams allow for the insertion of lengthwise support beams and their attachment using fasteners inserted through bores in the open-ended support beams and the lengthwise support beams. The system forms a rack that has a base or bottom rack that supports cargo and a back wall that prevents the cargo from coming into contact with and damaging the vehicle.

### BACKGROUND OF THE INVENTION

### (a) Field of the Invention

The present disclosure pertains to a vehicle rack. More particularly, this disclosure relates to a novel, modular vehicle rack for securing cargo that attaches to a vehicle via a receiver hitch.

### (b) Background Art

A lot of modern vehicles are equipped with a receiver hitch capable of accepting a variety of different mounts, carrier and other hitch mounted accessories. These types of receiver hitches consist of a structure mounted to the underside of the frame of the vehicle such that it presents an opening to accept accessories such as a ball mount. Through the use of the receiver hitch, there are a variety of different devices that can be connected to the back of a vehicle.

Trailers are probably the most common device to attach to a receiver hitch and tow by vehicle. Trailers are specifically designed to carry large heavy loads including other vehicles for long distances. However, trailers are very cumbersome and because they are typically attached using a ball mount that allows the trailer to swing from side to side, they make driving the vehicle and towing the trailer's contents significantly more difficult.

A number of other carriers have been developed over the years. Most of them require the use of a separate set of wheels to support a trailer and its contents. For example, U.S. Pat. No. 6,502,730 issued to Danny R. Johnson describes a trailer that mounts to three separate locations on the vehicle's receiver hitch and sports retractable wheels to provide enough support for the device to carry a significant amount of weight. Other carriers have been invented that do not involve equipping the carriers with a separate set of wheels; however, they typically are not capable of supporting large weights.

One of the other main drawbacks of these devices is that they provide no protection for the vehicle itself. When carrying large and/or heavy loads, there is a lot of potential for the weight placed on the trailer or carrier to shift and damage the vehicle. Such a risk is present every time the vehicle slows or stops as the inertia of the cargo will continue to carry the cargo forward towards the vehicle. For example, U.S. Pat. No. 6,554,171 issued to Melvin A. Ewing, III describes a device that is meant to support multiple golf bags, but contains no protection for the vehicle if indeed the weight of those golf bags shifts toward the back of the vehicle.

In addition, the trailers and trailer replacements on the market are large, bulky devices that are not easy to install, uninstall, ship or store. Some manufacturers address this problem by making the trailer or rack foldable such that it can be folded up or down when the rack is attached to a vehicle, but not in use. For example, U.S. Patent Publication Number US 2007/0175937 describes a foldable rack that can pivot downward to a substantially vertical position when the rack is not in use. However, such functionality does nothing to make the device easier to install or ship.

This disclosure relates to a modular vehicle cargo rack system and describes a cargo vehicle rack that mounts to a standard receiver hitch and is capable of carrying large loads without wheel support. In addition, the disclosure relates to a rack that protects the vehicle from being damaged by the cargo it carries. Further, this disclosure describes a vehicle rack that is modular and can be easily taken apart, assembled, installed, uninstalled, stored and shipped.

### BRIEF SUMMARY OF THE INVENTION

The present invention is a novel, modular vehicle cargo rack system or device. Preferred embodiments of the modular cargo vehicle rack system include a bottom frame or module that has means to attach the frame to the vehicle and means to attach a vertically oriented back frame or module to the bottom module. The bottom module is the portion of the modular cargo vehicle rack system that is horizontally oriented with respect to the ground such that it provides a surface upon which cargo can be placed. In preferred embodiments and the anticipated best mode of the modular vehicle cargo rack system, the bottom rack is made up of at least two crosswise support beams (“crosswise supports”) and two or more lengthwise support beams (“lengthwise supports”) and means to attach the frame to the vehicle. Crosswise supports extend horizontally from the user's left to the right when facing the back of the vehicle to which the system attaches. Similarly, lengthwise beams extend horizontally and perpendicularly or at an angle to the crosswise supports. For clarity, these same terms are used with respect to portions of the system that are vertically oriented as well. In that case, crosswise support beams are still oriented such that they extend from left to right as the user faces the back of the vehicle to which the system is attached. In such instances, the lengthwise support beams will extend up and down from that same viewer's point of view.

In preferred embodiments and the anticipated best mode of the modular vehicle cargo rack system, the means to connect the bottom frame to the vehicle include a lengthwise support beam that is sized and positioned to fit into a standard receiver hitch. Generally, this lengthwise support is positioned in the approximate center of the bottom frame. In this case “center” means approximately equal distance between a left edge of the bottom frame and a right end of the bottom frame. The positioning of this lengthwise support beam is not critical to the functioning of the modular cargo rack system, i.e., if this support is not positioned in the approximate center of the bottom frame, then the device will still function normally; although, it may be desirable to have the support near the center of the bottom frame to help balance the load placed in the rack in use.

In preferred embodiments and the inventor's anticipated best mode of the modular vehicle cargo rack system, the bottom frame of the rack has a horizontal support, either a lengthwise or a crosswise support, that includes a means of attaching another portion of the rack to the bottom rack. In preferred embodiments, the attachments means are beams that are oriented vertically and are at least partially hollow and open at one end. These vertically oriented, hollow, open-ended support beams are shaped and sized to accept a portion of another rack attached to the first or bottom rack or module. Ideally, these hollow supports are positioned vertically on a horizontal support that is nearest the back of the frame, i.e. the portion of the frame that is closest to the vehicle when in use. In preferred embodiments of the system, one or more of the hollow, vertical supports has a bore that passes through it. Ideally the bore traverses two of the opposing surfaces of the hollow vertical support such that a conventional fastener can be inserted into and through the bore and the hollow vertical support. In preferred embodiments, the bottom rack has four hollow vertical supports positioned on a horizontal support that is at the back of the rack system.

Preferred embodiments of the system include a second module referred to as a back frame consisting of both lengthwise and crosswise supports. When the back rack is releasably attached to the bottom rack the two racks or modules are at right angles to each other. While the angle between these two racks need not be exactly 90 degrees, preferred embodiments and the anticipated best mode of the system include a back rack that is oriented substantially perpendicularly to the bottom rack. Substantially perpendicular means within 10 degrees of 90 degrees.

The back frame also features means to releasably attach the back rack to the bottom rack. In preferred embodiments, the means to releasably attach the back rack to the bottom rack include inserting the bottom portion of one or more of the vertical supports of the back rack into the vertically oriented, hollow, open-ended support beams on the bottom rack. Preferred embodiments the bottom rack include one or more bores that pass through the hollow, open-ended support beams. These bores are positioned to align with more bore(s) in the vertically oriented lengthwise supports on the back rack such that a conventional fastener can be passed through both sets of bores to secure the back rack to the bottom rack. In preferred embodiments, a lynch pin or a nut and bolt are used to secure the two modules of the rack to each other. Other conventional fasteners such as a nut and bolt could also be used to secure the two modules of the rack to each other.

Preferred embodiments and the inventor's anticipated best mode of the modular vehicle cargo rack system also include a third module to the frame—a top frame. Similar to the back frame, the top frame also consists of lengthwise and crosswise supports as well as means to releasably attach the top rack to the back rack. The means to do so are similar to the means used to attach the back rack to the bottom rack. Similar to the bottom rack, the top rack's lengthwise supports can include vertically oriented, hollow, open-ended beams that are shaped and sized to accept a portion of another rack. These vertically oriented, hollow, open-ended support beams accept one or more of the vertically oriented, lengthwise support beams of the back rack inserted therein, thereby joining the two modules together.

In preferred embodiments of the rack, one or more of the hollow, open-ended support beams has a bore that passes through it. Ideally the bore traverses two opposing surfaces of the hollow vertical support such that a conventional fastener can be inserted into and through the bores in the lengthwise support beam of the back rack and the vertically oriented, hollow, open-ended support beams on the top rack. As above, preferred embodiments of the device use a lynch pin or a bolt and nut to secure the two modules to one another by inserting the lengthwise support beams of one module into the hollow supports of the other module and inserting a fastener through the bores on the vertical supports and the hollow supports when they are aligned. Structurally, the same result can be reached by equipping the back frame with the same vertically oriented, hollow, open-ended support beams and using them to accept portions of the lengthwise supports of either the top or bottom frame.

Preferred embodiments of the top rack include a plurality of vertically oriented, lengthwise support beams as well as one or more horizontally oriented crosswise support beams. Because this portion of the modular vehicle cargo rack system is positioned on top of the other two modules of the cargo rack system, it has the potential to block a portion of the user's view when the vehicle is in operation, in particular when the vehicle is being moved in reverse and the user needs to look past the modular vehicle cargo rack system in order to steer the vehicle. As a result, preferred embodiments of the top rack include angled support beams in place of one or more of the lengthwise or crosswise support beams. These angled supports typically extend down and away from the topmost crosswise support beam to connect to either another crosswise support, the hollow connecting piece attached to the top rack or a lengthwise support beam. In the inventor's anticipated best mode of the device, the top rack consists of two crosswise support beams connected to two lengthwise support beams and the two angled support beams.

When put into use, the lengthwise support beam that is part of the bottom rack is inserted in the receiver hitch on a vehicle and locked into place using conventional fastening means. Once the bottom rack is secured, the lengthwise support beams of the back rack are inserted into the vertically oriented, hollow, open-ended support beams on the bottom rack such that the bores align and a fastener can be inserted through each of the hollow vertical supports of the bottom rack and the bottommost portions of the lengthwise support beams of the back rack. Next the top rack is attached to the back rack by inserting the vertically oriented, hollow, open-ended support beams located on the bottommost portions of the lengthwise supports of the top rack over the topmost portions of the lengthwise supports of the back rack. The top rack is fastened to the back rack by inserting a fastener through the bores in the vertically oriented, hollow, open-ended support beams of one module and the bores in the lengthwise supports of the other module.

### BRIEF DESCRIPTION OF THE SEVERAL VIEWS OF THE DRAWING(S)

FIG. 1 is a perspective view of a preferred embodiment of the modular vehicle rack system fully assembled;

FIG. 2 is a perspective view of a preferred embodiment of the bottom rack module;

FIG. 3 is a perspective view of a preferred embodiment of the back rack module;

and

FIG. 4 is a perspective view of a preferred embodiment of the top rack module.

### DETAILED DESCRIPTION OF THE INVENTION

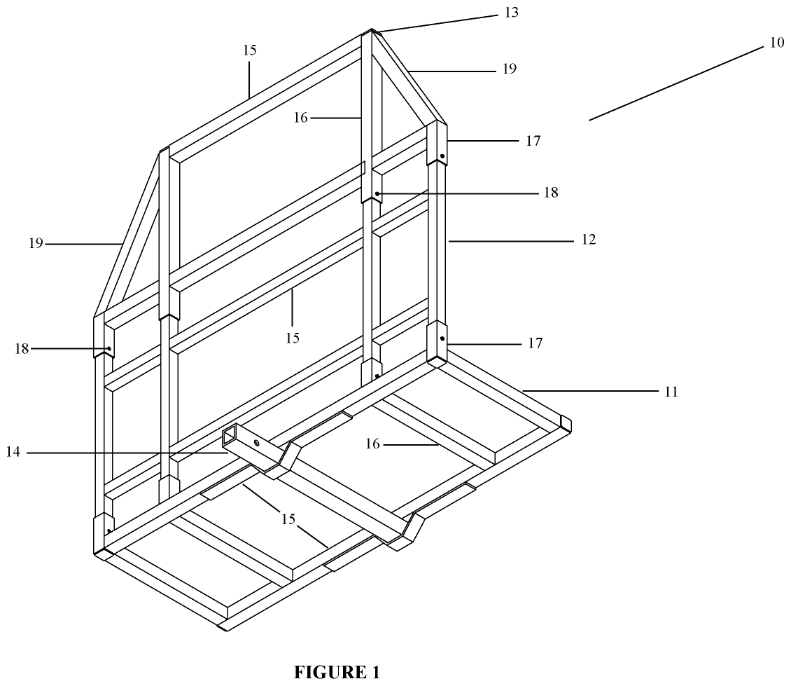

FIG. 1 shows a preferred embodiment of the modular vehicle cargo rack system 10 assembled, but not attached to a vehicle. Specifically, FIG. 1 shows the bottom rack or module 11, back rack or module 12 and top rack or module 13 attached to each other. In addition, FIG. 1 shows the means to connect the system to a standard receiver hitch, which in preferred embodiments is a lengthwise support beam referred to as a connection support beam 14 (connection that is configured to be inserted into a standard receiver hitch (not shown). This connection support beam 14 can an extended lengthwise support beam that forms the part of the bottom rack that supports cargo or, as shown in FIG. 1, it can be a separate beam attached to the underside of the bottom rack 11. The connection support beam 14 that provides connection to the receiver hitch necessarily protrudes away from the rest of the modular vehicle cargo rack system so as to allow it to be inserted fully into the receiver hitch and held securely in place. In preferred embodiments and the anticipated best mode of the system 10, this connection support beam 14 is the only point of connection between the vehicle and the modular vehicle cargo rack system 10.

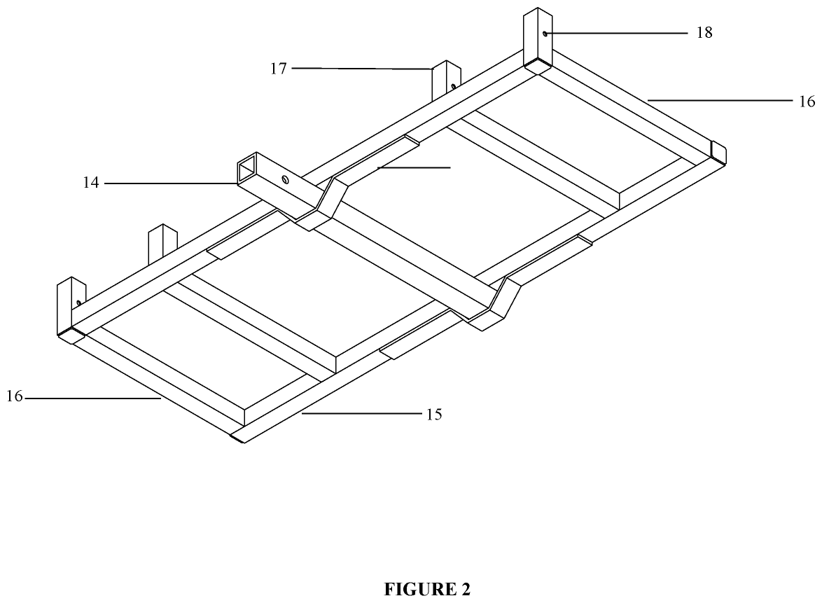

As shown in FIGS. 1 and 2, the bottom rack consists of at least two crosswise support beams 15 (“crosswise supports”) and two or more lengthwise support beams 16 (“lengthwise supports”). The terms crosswise and lengthwise are meant to refer to the positions of these support beams relative to the vehicle to which they are attached. Crosswise supports 15 extend horizontally from the user's left to the right when facing the vehicle to which the rack attaches, i.e. they are roughly parallel to the bumper of the vehicle. Similarly, lengthwise supports 16 lengthwise supports 16 extend perpendicularly or at an angle to the crosswise supports 15 and the bumper of the vehicle (not shown) to connect the crosswise supports 15. Preferred embodiments and the anticipated best mode of the modular vehicle cargo rack system 10 include four lengthwise supports 16 lengthwise supports 16 and two crosswise supports 15.

In addition, FIGS. 1 and 2, show the vertically oriented, hollow, open-ended support beams 17 that are part of or located on the surface of the bottom rack 11. In preferred embodiments, the back rack 12 features a plurality of hollow, vertically orientated support beams 17 (“hollow supports”) that can accommodate a portion of a separate structure being inserted therein. In the anticipated best mode of this system, the hollow supports 17 are featured and positioned such that they align with the vertically oriented lengthwise supports 16 located on the back rack 12 making it easy for the user to insert a portion of the back rack 12 into these lengthwise supports 16 such that the two parts of the system are joined together. These hollow supports 17 are oriented perpendicular or substantially perpendicular to the lengthwise and crosswise supports 15, 16. Alternate embodiments could feature different connection means between the back rack 12 and the bottom rack 11 including locating the hollow supports 17 on the bottommost surfaces of the lengthwise supports 16 that are part of the back rack 12 such that they fit over lengthwise supports 16 protruding from a surface of the bottom rack 11.

Each of the hollow supports 17 featured by the bottom rack 11 include a bore 18 that penetrates at least two surfaces of the hollow support 17. In preferred embodiments, the hollow supports 17 are square shaped tubes that are connected to the crosswise support beam 15 that winds up being closest to the vehicle when the system 10 is mounted onto a vehicle (not shown). The bore 18 that runs through each of these hollow supports 17 penetrates opposing surfaces of the square-shaped tube allowing for the insertion of a linear fastener, such as a lynch pin (not shown).

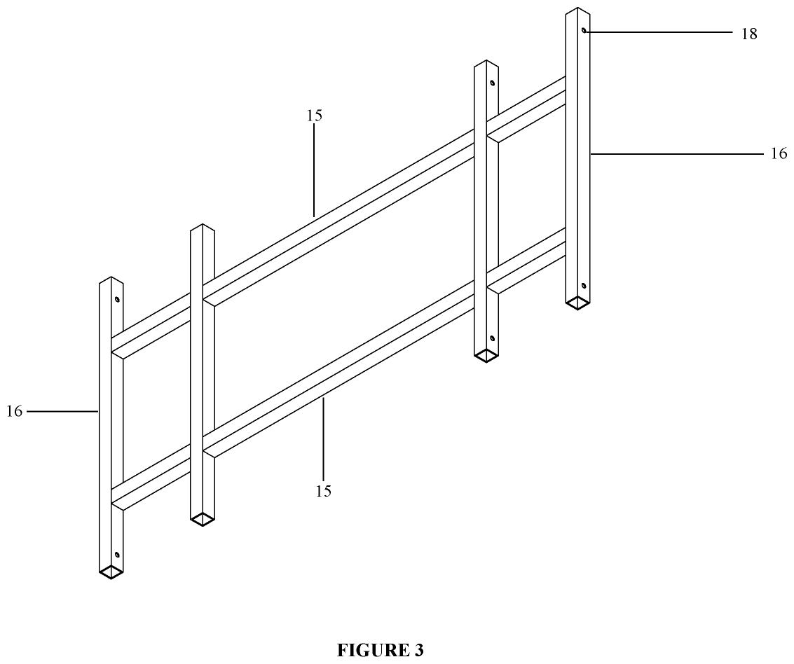

Referring back to FIG. 1, the back rack 12 is shown inserted into the hollow supports 17 of the bottom rack 11. FIG. 3, shows the back rack 12 in isolation. Preferred embodiments of the back rack 12 include at least two crosswise support beams 15 and at least two, preferably four, vertically oriented, lengthwise supports beams 16. The bottommost portion of the lengthwise supports 16 is shaped and positioned to be inserted into the hollow supports 17 featured by the back rack 12. These portions of the lengthwise supports 16 are necessarily shaped similar to the hollow supports 17. In preferred embodiments, the bottommost portions of the lengthwise supports 16 also feature at least one bore 18 that traverses two opposing sides of the lengthwise support 16. When the lengthwise supports 16 are inserted into the hollow supports 17, the bores 18 align allowing for the insertion of a linear fastener (not shown) through the bores 18 in the lengthwise supports 16 and the hollow supports 17.

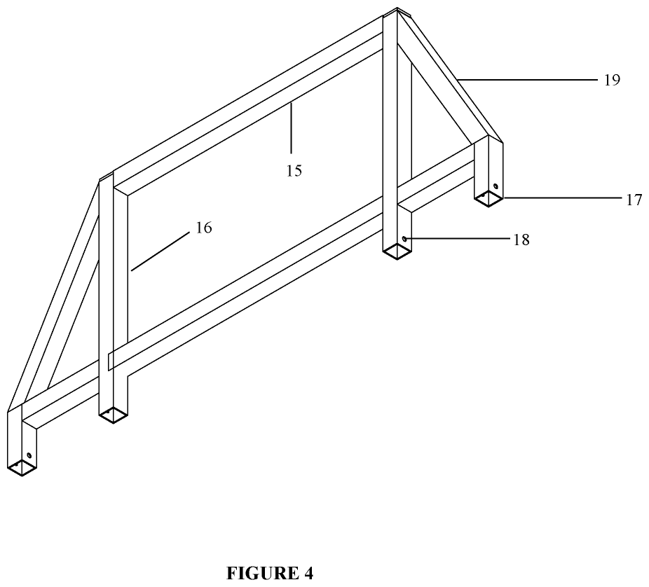

FIG. 4 shows the top rack module 13 in isolation. The top rack module 13 is shaped differently than the back rack module 12 to account for its position at the top of the modular vehicle cargo rack system 10. Since the modular vehicle cargo rack system 10 is designed to be attached to the rear of a vehicle, there is the potential for it to obstruct the view of the driver of the vehicle when they are attempting to look behind the vehicle. As a result, preferred embodiments of the top rack 13 feature angled supports 19 that are positioned at an angle to the other lengthwise supports 16 and the crosswise supports 15. The angle between the various components of the top rack 13 can vary, but in preferred embodiments of the modular vehicle cargo rack system 10, the angled support 19 forms a right triangle shape when attached to the crosswise and/or lengthwise supports 15, 16. FIG. 4 shows the three angles of the triangle shape—angle a is approximately 30 degrees, angle b is approximately 60 degrees and of course angle c is approximately 90 degrees. Approximately in this context means within 2.0 degrees of the specified number.

As shown in, in FIG. 4, preferred embodiments of the top rack module 13 feature at least two vertically oriented lengthwise supports 16, two angled supports 19 and two horizontally oriented crosswise supports 15. The top rack 13 also features a plurality of vertically oriented, hollow, open-ended support beams 17 (“hollow supports”) into which portions of the back rack 12 can be inserted. The top rack 13 is attached to the back rack 12 in much the same way as the back rack 12 and the bottom rack 11 are attached to each other. In preferred embodiments and the anticipated best mode of the device, the hollow supports 17 are featured either at the bottommost portion of the lengthwise and angled supports 19 or on a downward facing surface of one of the crosswise supports 15 thereby allowing those hollow supports 17 to fit over the uppermost portions of the lengthwise support beams on the back rack module 12. As above, the hollow, vertical supports 17 feature a bore 18 running through two opposing surfaces of a square shaped, hollow beam that aligns with a bore 18 that traverses a portion of the lengthwise supports 15 on the back rack 12 allowing for the insertion of a linear fastener.

To install the device on a vehicle, the connection support beam 14 is inserted and installed in the receiver hitch (not shown) on a vehicle. The bottom rack 11 is thereby secured to the vehicle. Next, the lengthwise support beams 16 of the back rack 12 are inserted into the hollow supports 17 on the bottom rack 11 such that the bores 18 align and a fastener is inserted through each of the hollow supports 17 of the bottom rack 11 and the bottommost portions of the lengthwise supports 16 of the back rack 12. Next the top rack 13 is attached to the back rack 12 by inserting the hollow supports 17 located on the top rack 13 over the topmost portions of the lengthwise supports 16 of the back rack 12. The top rack 13 is fastened to the back rack 12 by inserting a fastener through the bores 18 in the hollow supports 17 of one module and the bores 18 in the lengthwise supports 16 of the other module.

The advantages of the present invention include, without limitation, the ability to transport large amounts of cargo without the use of a separate trailer that requires its own wheels to support it. Further, the advantages of the present invention include the ability to assemble and disassemble the rack in pieces making it easier and less cumbersome to handle. Further, the present invention provides protection for the vehicle transporting cargo with the rack as the back and top rack modules prevent the cargo from coming into contact with the vehicle during transport. These and many other advantages will be apparent to those of skill in the art.

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I/We claim:

1. A modular cargo rack for a vehicle featuring a receiver hitch comprising:
a bottom module with at least one support beam configured to be inserted into the vehicle's hitch, and
a back module removably joined to the bottom module.

2. The modular carrier rack for a vehicle of claim 1 further comprising a top module that is removably joined to the back module.

3. The modular carrier rack for a vehicle of claim 1 wherein the bottom module features a plurality of vertically oriented, open-ended hollow beams and the back module features a plurality of vertically oriented, lengthwise support beams, wherein the back module is releasably joined to the bottom module by inserting at least one of the plurality of lengthwise support beams of the back module into at least one of the plurality of hollow beams of the bottom module.

4. The modular carrier rack for a vehicle of claim 2 wherein the top module releasably attaches to the back module by inserting the ends of a plurality of lengthwise support beams featured by the back module into a plurality of hollow, open-ended support beams featured by the top module.

5. The modular carrier rack for a vehicle of claim 3 wherein the top module releasably attaches to the back module by inserting the ends of a plurality of vertical support beams featured by the back module into hollow, open-ended beams featured by the top module.

6. The modular carrier rack for a vehicle of claim 4 wherein the top module further comprises two horizontally oriented crosswise support beams attached to at least two vertically oriented, lengthwise support beams and at least two angled supports that extend from one crosswise support beam to a second crosswise support beam at an acute angle.

7. The modular carrier rack for a vehicle of claim 5 wherein the top module further comprises two horizontally oriented crosswise support beams attached to at least two vertically oriented, lengthwise support beams and at least two angled supports that extend from one crosswise support beam to a second crosswise support beam at an acute angle.

8. The modular carrier rack for a vehicle of claim 7 further comprising a first set of bores each of which passes completely through each of two opposing surfaces of the hollow, open-ended support beam of the bottom module, said first set of bores being aligned with a second set of bores each of which completely passes through a bottom end of a lengthwise support beam of the back module when the bottom end of the lengthwise support beam is inserted into an open end of the open-ended support beams of the bottom module.

9. The modular carrier rack for a vehicle of claim 8 further comprising a third set of bores each of which passes completely through each of two surfaces of the hollow, open-ended support beams of the top module said third set of bores being aligned with a fourth set of bores each of which completely passes through a top end of a vertically oriented lengthwise support beam of the back module when the top end of the lengthwise support beam of the back module is inserted into the hollow open-ended support beams of the top module.

10: A modular cargo rack for a vehicle featuring a receiver hitch comprising:
a bottom frame having a plurality of horizontally oriented crosswise support beams, a plurality of vertically oriented lengthwise support beams positioned substantially perpendicularly to the plurality of crosswise support beams, at least one beam extending away from the crosswise and lengthwise support beams configured to be inserted into the vehicle's receiver hitch, and a plurality of vertically oriented, hollow, open-ended support beams.

11: The modular vehicle cargo rack of claim 10 further comprising a top frame having a plurality of horizontally oriented crosswise support beams, a plurality of vertically oriented lengthwise beams positioned substantially perpendicularly to the plurality of crosswise support beams and a plurality of angled support beams connecting the lengthwise support beams and the crosswise support beams.

12: The modular vehicle cargo rack of claim 11 further comprising a back frame with a plurality of horizontally oriented crosswise support beams, a plurality of vertically oriented lengthwise beams positioned substantially perpendicularly to the plurality of crosswise support beams and configured to be partially inserted into the hollow, open-ended support beams of the bottom frame.

13: The modular vehicle cargo rack of claim 12 wherein each of the vertically oriented lengthwise beams of the top frame is hollow and open at one end and configured to be inserted over the plurality of vertically oriented lengthwise beams of the back frame.

14: The modular vehicle cargo rack of claim 13 further comprising:
a first plurality of bores traversing two opposing surfaces of each of the vertically oriented, hollow, open-ended support beams on the bottom frame;
a second plurality of bores traversing two opposing surfaces of each of the plurality of vertically oriented lengthwise beams of the back frame; and
a third plurality of bores traversing two opposing surfaces of each of the vertically oriented lengthwise beams of the back frame; wherein said second plurality of bores and said third plurality of bores are located at opposing ends of each of the vertically oriented lengthwise beams of the back frame.

15: The modular vehicle cargo rack of claim 14 further comprising a fourth plurality of bores traversing two opposing surfaces of each of the plurality of vertically oriented lengthwise beams of the top frame; wherein the third plurality of bores and the fourth plurality of bores align when the lengthwise beams of the top rack are inserted over the lengthwise beams of the back rack.

16: A system for carrying cargo using a vehicle having a receiver hitch comprising a plurality of modules that when connected form a platform capable of supporting cargo and a wall positioned between the cargo and the vehicle.
